(19) United States
(12) Patent Application Publication
(10) Pub. No.: US 2008/0230013 A1
(43) Pub. Date: Sep. 25, 2008

(54) INTERACTIVE PET AMUSEMENT DEVICE AND METHOD FOR USE

(75) Inventor: Fung Kin Man, Tsueng Kwan O (HK)

Correspondence Address: MARSH, FISCHMANN & BREYFOGLE LLP, 3151 SOUTH VAUGHN WAY, SUITE 411, AURORA, CO, 80014, US

(73) Assignee: TOPET (H.K.) CO., LIMITED, Kowloon (HK)

(21) Appl. No.: 12/053,389

(22) Filed: Mar. 21, 2008

Related U.S. Application Data
(60) Provisional application No. 60/896,334, filed on Mar. 22, 2007.

(51) Int. Cl. A01K 29/00

(52) U.S. Cl. 119/708

(57) ABSTRACT

A device for interactive use with a pet animal and a method for interacting with a pet animal. The device can attach to a person's foot and includes a support arm that extends from the person's foot. A toy is attached to a distal end of the support arm, such as by using a strand to affix the toy to the support arm. In this manner, the person can manipulate the toy using the person's foot to amuse the pet animal without requiring the person to utilize their hands or arms to provide the toy motion. The device can include a base member that fastens to the person's foot, where the support arm extends from the base member. The device can also include a second toy that can attach to the base member when the support arm is removed from the base member.

### CROSS-REFERENCE TO RELATED APPLICATIONS

This application claims priority to U.S. Provisional Patent Application Ser. No. 60/896,334, filed Mar. 22, 2007, the disclosure of which is incorporated herein by reference in its entirety.

### BACKGROUND OF THE INVENTION

1. Field of the Invention

This invention relates to the field of pet toys that are adapted to be used interactively between a pet animal and a person.

2. Description of Related Art

There are a variety of pet amusement and exercise devices that are adapted to exercise and entertain household domestic pet animals, such as a cat, dog, rabbit, ferret or the like. Some of these devices entertain the animal by simulating the movement of small prey such as a mouse, allowing the animal to utilize its natural hunting instincts.

U.S. Pat. No. 5,829,391 by Krietzman discloses a pet amusement and exercise device which is mounted under a door. The device includes a U-shaped mounting bracket adapted to fit under the bottom edge of a door, a flexible wand extending from the mounting bracket, and a target object attached to an end of the flexible wand. The device does not enable interactive play between a pet and a person.

U.S. Pat. No. 5,148,769 by Zelinger discloses a pet amusement device that includes a suction cup that can be removably mounted onto a surface, a spring-like wire mounted onto the suction cup base and a toy mounted on the end of the wire that can be batted by the animal. This device also does not enable interactive play between a pet and a person.

U.S. Pat. No. 6,378,464 and U.S. Pat. No. 6,481,381, both by Ritchey, disclose a pet amusement device that includes a toy disposed at the end of a wand so that the device can be used in a fishing pole manner to entertain and exercise a pet animal. Similar devices are disclosed U.S. Pat. No. 4,499,855 by Galkiewicz, U.S. Pat. No. 5,467,740 by Redwine, U.S. Pat. No. 5,743,215 by Zeff and U.S. Pat. No. 6,314,913 by Lettau et al.

While some of these devices enable direct interaction between a pet and a person, they require the person to utilize one or both hands to manipulate the toy and interact with the pet. This can distract the human from simultaneously partaking in other activities that require the use of their hands such as reading. Further, the elongate poles used by same prior art devices must be held up in the air and moved about by the person, which can quickly fatigue the person's arms.

### SUMMARY OF THE INVENTION

Accordingly, it is an object of the present invention to provide an amusement device and method for amusing a pet animal that overcome one or more of the disadvantages of the prior art devices. According to one aspect, a person can interact with the pet animal by moving a toy in the air or along the ground without requiring the person to utilize their hands and arms to provide the toy motion.

In one embodiment, a device is provided that is adapted for interactive use with a pet animal. The device includes a support arm having a distal end. A toy is affixed to the distal end of the support arm. The support arm can be attached to a person's foot such that the toy can be moved in a variety of directions to amuse and exercise the pet animal.

In one aspect, the support arm can be attached to a person's foot using a base member that is adapted to fasten to the front of a person's foot. The support arm extends from the base member and the person can easily manipulate the toy to amuse a pet animal. In one aspect, the base member can include a substantially concave inner surface that is adapted to at least partially conform to the front of a person's foot. According to another aspect, the device includes an elastic band or a strap, such as a nylon strap, that is adapted to wrap around a person's heel to secure the device to the person's foot. The strap can be tightened and secured to the person's foot using a buckle or hook and loop fasteners. For example, the elastic band or strap can be coupled to the base member to urge a base member against the front of a person's foot.

When the device includes a base member, the support arm can be permanently attached to the base member, or alternatively can be removably attached to the base member. According to one aspect, when the support arm is removably attached to the base member, the support arm can be removed and reattached to the base member without the use of tools. According to another aspect, the device can further include at least a second toy that can be removably attached to the base member, such as by removably attaching to the base member in place of the first toy. The second toy can include a laser pointer that can be manipulated to amuse a pet animal.

The support arm can be substantially straight or it can curve outwardly when the device is attached to a person's foot and the distal end of the support arm can include an aperture for attaching the toy to the support arm. For example, the toy can attach to the distal end of the support arm using a strand, such as a strand of common string or fishing line. To enable the toy to be supported above ground level without requiring the person to maintain their foot elevated in the air, the strand to which the toy is attached can have a length that is not greater than the length of the support arm.

In another embodiment, a device is provided that is adapted for interactive use with a pet animal where the device includes a base member that is adapted to removably attach to the front of a person's foot. A support arm extends outwardly and upwardly from the base member when the base member is attached to the person's foot. A first toy is attached to a distal end of the support arm such that the person can move his or her foot to manipulate the toy and amuse the pet animal.

In one aspect, the device includes an elastic band that is adapted to wrap around the person's heel and urge the base member against the front of the person's foot. According to another aspect, the device includes a strap that is adapted to wrap around a person's heel and urge the base member against the front of the person's foot. According to another aspect, the toy is affixed to the support arm by a strand, where the strand has a length between the distal end of the support arm and the first toy that is not greater than the length of the support arm.

According to another aspect, the support arm is removably attached to the base member. In this regard, the device can include at least a second toy, where the second toy can be removably attached to the base member in place of the first toy. According to one aspect, the second toy is a laser pointer.

The present invention also provides a method for interactively amusing a pet animal. The method can include providing a support arm having a distal end, attaching a toy to the distal end of the support arm, attaching the support arm to a person's foot such that the support arm extends upwardly therefrom, and moving the person's foot to cause movement of the toy for the amusement of a pet animal. According to one aspect, the step of attaching the support arm to the front of a person's foot includes attaching a base member to the person's foot where the support arm extends from the base member. According to another aspect, the method further includes the steps of removing the support arm from the front of the person's foot and attaching a second toy to the front of the person's foot for further amusement of the pet animal.

### DESCRIPTION OF THE DRAWINGS

FIG. 1 illustrates a perspective view of an interactive pet amusement device.

FIGS. 2(a) to 2(c) illustrate different perspective views of an interactive pet amusement device.

FIG. 3 illustrates a method for interactively amusing a pet animal.

FIGS. 4(a) and 4(b) illustrate an interactive pet amusement device having multiple detachable toys.

### DESCRIPTION OF THE INVENTION

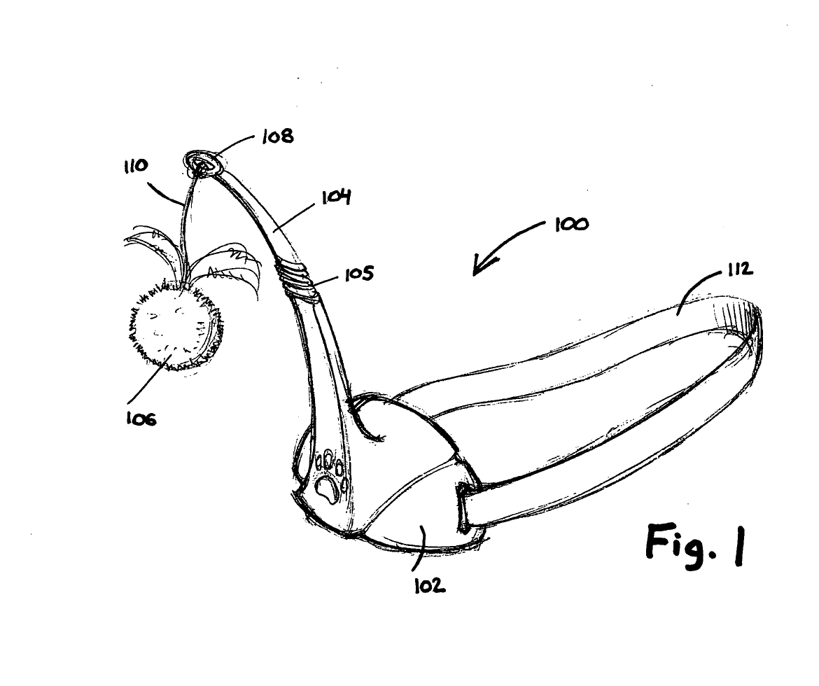

FIG. 1 illustrates a device that is adapted for interactive use with a pet animal. The device 100 includes a support arm 104 that is attached to and extends upwardly from a base member 102. A toy 106 is affixed to a distal end of the support arm 104 by a strand 110. An elastic band 112 is also coupled to the base member 102 and forms a loop that can secure the base member 102 onto the foot of a person by wrapping the elastic band 112 around a person's heel.

Accordingly, the support arm 104 can attach to a person's foot through the base member 102 which can be urged against the front of a person's foot by the elastic band 112. The base member 102 advantageously provides a stable attachment of a support arm to the person's foot. Alternatively, a support arm could be attached to a person's foot by other means, such as by simply by attaching the support arm to an elastic band or strap that wraps around the metatarsus region of a person's foot to secure the support arm to the person's foot.

In the embodiment illustrated in FIG. 1, the support arm 104 is attached to a person's foot using the base member 102 and the elastic band 112. The base member 102 is adapted to be removably fastened to a foot, such as by securely fastening to the front of a shoe or sneaker on a person's foot. As illustrated in FIG. 1, the base member 102 is adapted to at least partially conform around the front of a person's foot. A base member could also fasten to a user's foot in a different position, such as a base member that partially or wholly extends around the metatarsus region between the toe and heel of a person's foot. A base member can also comprise an entire shoe that can be worn on a person's foot where a support arm is attached to and extends from the shoe.

A base member such as base member 102 that fastens to the front of a person's foot is preferred, as that enables the support arm 104 to be disposed over the person's toes. This permits a person to more easily move the base member 102 by raising and lowering the front of their foot, and hence more easily move the toy 106 in a manner that is amusing for a pet animal and puts minimal strain on the user. The base member 102 can also be easily removed from and re-fastened to the person's foot.

The base member 102 can be configured to fasten to and remain on the person's foot during use by simply pressing the base member 102 onto the front of the person's foot so that the base member frictionally engages the front of the foot, such as by engaging a shoe worn by the person. The base member 102 can have a substantially concave inner surface that presses up against the front of the person's foot. For example, the base member could include a u-shaped member of a resilient material that fastens to the front of a person's foot.

The device can also include an elastic band, a strap or a similar means for urging the base member 102 against the person's foot. As illustrated in FIG. 1, the device includes an elastic band 112 that is coupled to the base member 102 and is adapted to wrap around the heel of a person's foot. In addition to an elastic band (e.g., a rubber band), a strap such as a nylon strap, with an attachment mechanism such as a buckle or a hook-and-loop fastener, can be used to secure the base member 102 to a person's foot.

Thus, the toy support arm 104 is preferably attached to a person's foot through a base member 102. The toy support arm 104 can be permanently attached to the base member 102, such as where the support arm and base member are integrally formed together as illustrated in FIG. 1, or can be removably attached to the base member 102. A removable support arm can simplify and facilitate packaging and shipping of the device 100, as well as storage of the device 100 when not in use. If the support arm 104 is removably attached, it is preferred that the support arm 104 can be removed and re-attached to the base member 102 without the use of tools.

The support arm 104 extends upwardly from the base member 102. The support arm 104 can also extend outwardly from the base member 102 when the device 100 is fastened onto a person's foot. A support arm that is adapted to extend both upwardly and outwardly advantageously maintains the toy 106 in spaced-apart relation with respect to the base member 102 so that the person's foot is less likely to interfere with the pet animal during use. The support arm can be substantially straight or, as is illustrated FIG. 1, can be curved outwardly from the front of the base member 102. Further, the support arm 104 can be substantially rigid, or can be resiliently flexible such that the pet animal can pull the arm slightly downward when tugging at the toy 106. To provide flexibility, the support arm 104 can include a mid-portion 105 that is adapted to increase the flexibility of the support arm, such as by having a reduced cross-section or by being fabricated from a material having greater flexibility than the remainder of the support arm. For example, the mid-portion 105 can include notches in the support arm such that the support arm has a reduced cross-section in the mid-portion 105.

The support arm 104 preferably has a length that is conducive to use with a pet animal such as a cat, and in one embodiment has a length of at least about 5 centimeters and not greater than about 30 centimeters, such as at least about 10 centimeters and not greater than about 20 centimeters. Since the device is used in close proximity to the ground, the support arm can advantageously have a length that is substantially less than the length of fishing rod type pet amusement devices that are operated by hand.

A toy 106 that is attractive for the pet animal is affixed to the support arm 104, preferably to a distal end of the support arm 104. Examples include soft plush style toys that give the appearance of small prey. The toy 106 can be affixed, for example, using a strand 110 that attaches to an aperture 108 at the distal end of the support arm 102, with the toy being attached to the opposite end of the strand 110. Preferably, the toy 106 is removably attached to the support arm. A removable toy enables a user to easily place different toys onto the end of the support arm 104, such as when a toy wears out or the pet animal becomes bored with a particular toy. The strand 110 can be, for example, common string, fishing line, or the like. Alternatively, a toy can be attached directly to the support arm 104, without the use of a separate strand.

When the toy 106 is attached to the support arm 104 using a strand 110, the strand 110 preferably has a length that is not greater than the length of the support arm 104. That is, the length of the strand 110 between the distal end of the support arm and the pet toy 106 is no longer than the length of the support arm. In this manner, the toy 106 can be easily suspended above the ground by the user without requiring the user to maintain their foot in an elevated position.

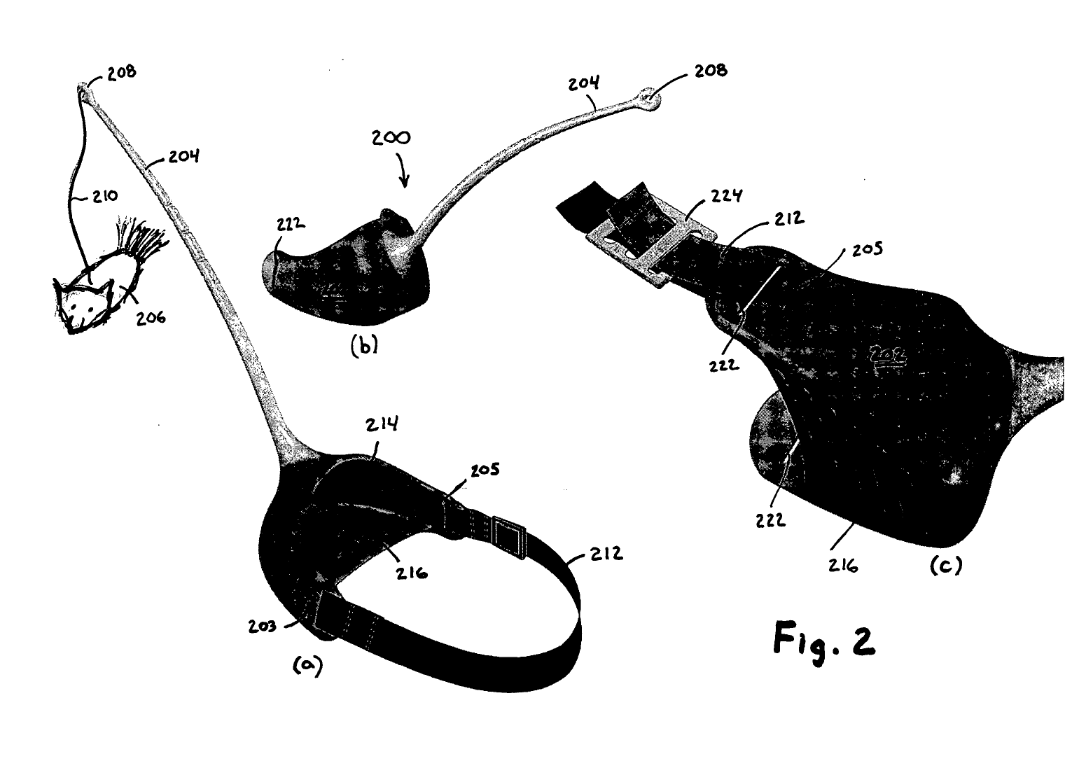

FIG. 2(a) to 2(c) illustrate different perspective views of an interactive pet amusement device 200. The device 200 includes a toy support arm 204 that can be attached to a person's foot, and a toy 206 affixed to a distal end of the support arm 204. In the embodiment illustrated in FIGS. 2(a) to 2(c), the support arm 204 is attached to a person's foot using base member 202, which is adapted to fasten to the front of a person's foot. In this regard, the base member 202 includes a substantially concave inner surface 214 that is adapted to at least partially conform to the front of a person's foot. The base member 202 also includes side portions 203 and 205 that extend at least partially along the sides of the person's foot. The base member 202 can also include a bottom wall 216 to help secure the base member 202 to a person's foot. The bottom surface of the bottom wall 216 can be provided with grooves or projections adapted to provide traction on a floor when a user walks with the device 200 attached to their foot.

The device 200 also includes a strap 212 that is coupled to the side portions 203 and 205 of the base member to help secure the base member 202 to a person's foot. In this regard, the base member 202 can include slits 222 adapted to receive and secure the strap 212 to the base member 202. As illustrated in FIG. 2, the strap 212 is secured to a user's foot using a clip 224.

The support arm 204 extends upwardly and outwardly from the base member 202 when the base member is attached to a person's foot. A toy 206 is attached to a distal end of the support arm 204 by a strand 210 tied or otherwise fastened to an aperture 208 in the support arm.

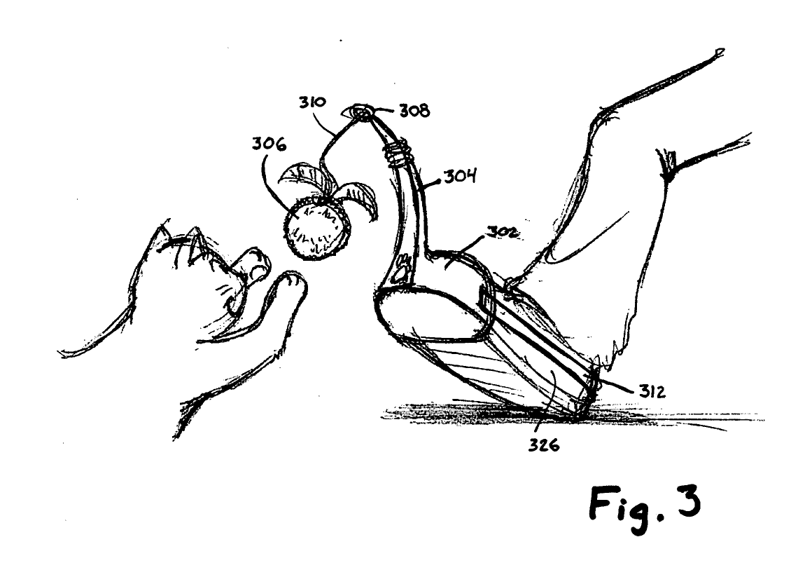

FIG. 3 illustrates a method for amusing a pet animal using an interactive pet amusement device. A support arm 304 is provided and is attached to the front of a user's foot 326. A toy 306 is affixed to a distal end of the support arm 304 through a strand 310 that is secured to a distal end of the support arm through an aperture 308 located at the distal end. The support arm 304 is attached to a base member 302 and the base member is fastened to the user's foot using a band 312. The support arm 304 thereby extends upwardly from the user's foot 326. A user can advantageously cause movement of the toy 306 to amuse and exercise the pet animal by simply moving the front end of their foot in a multitude of directions.

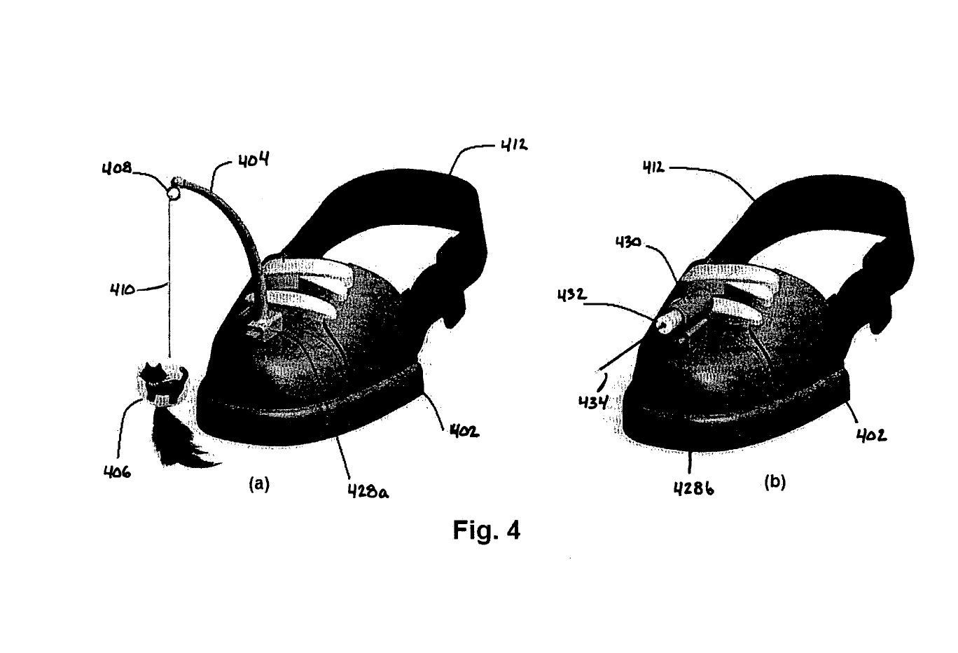

As is noted above, the toy support arm can be removably attached to a base member, and the support arm can preferably be removed and re-attached to the base member without the use of tools. FIG. 4 illustrates an interactive pet amusement device where the support arm is detachable from the base member and is interchangeable with a second toy, such as a laser pointer.

FIG. 4(a) illustrates an interactive pet amusement device which includes a base member 402 and a strap 412 for securing the base member to a user's foot. A support arm 404 includes an aperture 408 to which a strand 410 is attached. A toy 406 is affixed to the opposite end of the strand 410, as is noted above with respect to FIGS. 1-2.

A fastener 428(a) is disposed at a proximal end of the support arm 404 opposite the aperture 408 for removably attaching the support arm 404 to the base member 402, which includes a mating fastener to receive and secure the arm fastener 428(a). Through use of the fastener 428(a), the support arm 404 can be removed and re-attached to the base member 402, preferably without the use of tools.

In one embodiment, a second toy, such as a toy that is different than the toy 406 can also be provided, including a toy that does not require the use of the support arm 404. In the embodiment illustrated in FIG. 4(b), the second toy includes a laser pointer 432 that is supported by a holder 430. The holder 430 is mounted to the base member 402 using a fastener 428(b) that is substantially identical to the fastener 428(a) that mounts the support arm 404 to the base member 402. In this manner, the user can select the toy 406 or a laser pointer 432 for amusing the pet animal. In the embodiment illustrated in FIG. 4(b), the user can move his or her foot in a manner to cause the bright pattern of light 434 formed by the laser pointer 432 to amuse the pet animal.

Thus, the interactive pet amusement device can include a base member and two or more pet toys that can be interchangeably mounted onto the base member for the continued stimulation and exercise of a pet animal.

The device and method of the present invention advantageously enable a user to interactively play with a pet animal while simultaneously maintaining the ability to perform other tasks that require the use of hands, such as reading. Further, the user is more likely to be able to play with the pet animal for an extended period of time without becoming tired. The device can advantageously be used, for example, when the user is in a sitting position.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A device that is adapted for interactive use with a pet animal, the device comprising:
a support arm having a distal end;
a first toy affixed to said distal end of said support arm; and
means for attaching said support arm to a person's foot.

2. A device as recited in claim 1, wherein said attaching means comprises a base member that is adapted to fasten to the front of a person's foot, wherein said support arm extends from said base member.

3. A device as recited in claim 2, wherein said base member comprises a substantially concave inner surface that is adapted to at least partially conform to the front of a person's foot.

4. A device as recited in claim 1, wherein said attaching means comprises an elastic band that is adapted to wrap around a person's heel.

5. A device as recited in claim 2, wherein said attaching means further comprises an elastic band coupled to said base member wherein said elastic band is adapted to wrap around a person's heel and urge said base member against the front of a person's foot.

6. A device as recited in claim 1, wherein said attaching means further comprises a strap that is adapted to wrap around a person's heel.

7. A device as recited in claim 2, wherein said attaching means further comprises a strap coupled to said base member wherein said strap is adapted to wrap around a person's heel and urge said base member against the front of a person's foot.

8. A device as recited in claim 2, wherein said support arm is permanently attached to said base member.

9. A device as recited in claim 2, wherein said support arm is removably attached to said base member.

10. A device as recited in claim 9, wherein said support arm is adapted to be removed from and attached to said base member without the use of tools.

11. A device as recited in claim 9, wherein said device further comprises at least a second toy that can be removably attached to said base member.

12. A device as recited in claim 11, wherein said second toy comprises a laser pointer.

13. A device as recited in claim 2, wherein said support arm is substantially straight.

14. A device as recited in claim 2, wherein said support arm is curved.

15. A device as recited in claim 2, wherein said distal end of said support arm comprises an aperture for affixing said first toy to said support arm.

16. A device as recited in claim 2, wherein said first toy is affixed to said distal end of said support arm by a strand.

17. A device as recited in claim 16, wherein said strand has a length that is not greater than the length of said support arm.

18. A device adapted for interactive use with a pet animal, the device comprising:
a base member that is adapted to removably attach to the front of a person's foot;
a support arm extending outwardly and upwardly from said base member; and
a first toy attached to a distal end of said support arm.

19. A device as recited in claim 18, further comprising an elastic band that is adapted to wrap around a person's heel and urge said base member against the front of a person's foot.

20. A device as recited in claim 18, further comprising a strap that is adapted to wrap around a person's heel and urge said base member against the front of a person's foot.

21. A device as recited in claim 18, wherein said first toy is affixed to said support arm by a strand, wherein said strand has a length that is not greater than the length of said support arm.

22. A device as recited in claim 18, wherein said support arm is removably attached to said base member.

23. A device as recited in claim 22, wherein said device further comprises at least a second toy, wherein said second toy can be removably attached to said base member.

24. A device as recited in claim 23, wherein said second toy comprises a laser pointer.

25. A method for interactively amusing a pet animal, comprising the steps of:
providing a support arm having a distal end;
affixing a first toy to said support arm;
attaching said support arm to the front of a person's foot, wherein the support arm extends upwardly from the person's foot; and
moving the person's foot to cause movement of said toy for the amusement of a pet animal.

26. A method as recited in claim 25, wherein said step of attaching said support arm to the front of a person's foot comprises attaching a base member to a person's foot, where said support arm extends from said base member.

27. A method as recited in claim 26, further comprising the steps of:
removing said support arm from said base member; and
attaching a second toy to said base member.
